(19) United States
(12) Patent Application Publication
(10) Pub. No.: US 2023/0250005 A1
(43) Pub. Date: Aug. 10, 2023

(54) METHOD OF DEWATERING SLUDGE

(71) Applicant: SOLENIS TECHNOLOGIES, L.P., Wilmington, DE (US)

(72) Inventors: Nathalie Bruzzano, Duisburg (DE); Frank Moskwa, Willich (DE); Markus Bröcher, Mühlheim an der Ruhr (DE)

(73) Assignee: SOLENIS TECHNOLOGIES, L.P., Wilmington, DE (US)

(21) Appl. No.: 18/165,993

(22) Filed: Feb. 8, 2023

Related U.S. Application Data
(60) Provisional application No. 63/267,675, filed on Feb. 8, 2022.

(51) Int. Cl. C02F 11/147; C08L 53/00

(52) U.S. Cl. CPC C02F 11/147; C08L 53/00

(57) ABSTRACT

Provided is a method of dewatering aqueous sludge that is produced by waste water or sewage treatment facilities, such as from industrial and municipal processes. The method includes treating an aqueous sludge with an associative and branching or cross-linked inverse emulsion cationic polymer, wherein the associative properties of the cationic polymer are provided by an emulsification surfactant(s) chosen from diblock and triblock polymeric surfactants and/or cross-linking agents.

### CROSS-REFERENCE TO RELATED APPLICATION

This application claims the benefit of U.S. Provisional application No. 63/267,675, filed 8 Feb. 2022, the entire contents of which are hereby incorporated by reference.

### TECHNICAL FIELD

The present disclosure generally relates to dewatering aqueous sludge that is produced by waste water or sewage treatment facilities such as from municipal and industrial processes. The method includes treating an aqueous sludge with an associative and branching or cross-linked inverse emulsion cationic polymer that is physically and chemically cross-linked with diblock and triblock polymeric surfactants, and cross-linking agents.

### BACKGROUND

The effluent streams coming from the processes mentioned above generally contain waste solids that cannot be directly recycled and are conveyed by a sewerage system to a waste water treatment plant facility. The effluent stream goes through a series of operations depending on the particular industry and set-up of the waste water treatment facility, to concentrate and dewater the waste solids thereby producing a sludge. Ultimately, the industrial effluent stream is passed through a filter press, such as, a chamber filter press, plate filter press, frame filter press, membrane filter press, screw filter press and belt filter press or through a centrifuge, wherein the waste solids are concentrated into a primary sludge or filter cake and the filtered waste water from the press or centrifuge is further processed until it is fit for discharge or reuse.

A typical sewage treatment plant takes in raw sewage and produces solids and clarified water. Typically the raw sewage is treated in a primary sedimentation stage to form a primary sludge and supernatant, the supernatant is subjected to biological treatment and then a secondary sedimentation stage to form a secondary sludge and clarified liquor, which is often subjected to further treatment before discharge.

It is standard practice to dewater the sludge by mixing a dose of polymeric flocculant into that sludge at a dosing point, and then substantially immediately subjecting the sludge to the dewatering process and thereby forming a cake and a reject liquor. The dewatering process may be centrifugation or may be by processes such as filter pressing or belt pressing.

In many countries, for regulatory reasons, most sludge cake is going to landfill. For landfill, the cake must be drier than 40% and also the amount of sludge going into any landfill must not be greater than 8% (mixture ratio). Therefore, it is desirable (i) to increase the content of separated dry matter (OS), if possible above about 40 wt.-%, i.e. to keep the sludge cake moisture below about 60 wt.-% using current processes.

In conventional processes of dewatering aqueous sludge various ionic, anionic and cationic polymers have been added to aqueous sludge as polymeric flocculants to induce flocculation formation of the solid materials in the sludge. Other methods have included adding quick lime (CaO) to the aqueous sludge in order to increase dry matter contents (OS). However, the addition of quick lime is expensive and laborious Therefore, there is a demand for simple processes for dewatering sludge which achieves high solids contents. In particular, it is an objective to increase the residual dry matter in the filter cake of dewatered sludge and to decrease the moisture content in the filter cake, respectively.

Therefore, it was an objective to provide copolymer compositions that show improved performance as a dewatering aid for sludge dewatering in waste water and sewage treatment.

The produced composition is an associative and crosslinked polymer and provides a physically and chemically cross-linked composition having improved efficacy in dewatering aqueous sludge.

### BRIEF SUMMARY

The present disclosure relates to a method of treating an aqueous sludge with a associative and branched or crosslinked polymer composition comprising at least one associative inverse emulsion cationic polymer, wherein the associative properties of the cationic polymer are provided by an emulsification surfactant chosen from diblock and triblock polymeric surfactants. wherein the at least one associative inverse emulsion cationic polymer comprises one or more polymer segment “A” comprised of ethylenically unsaturated nonionic monomers; and one or more cationic polymer segment “B” comprised of ethylenically unsaturated cationic monomers; and a cross-linking agent. The composition also includes an emulsification surfactant chosen from diblock polymeric surfactants, triblock polymeric surfactants and combinations thereof; wherein the molar ratio of the emulsification surfactant to a combination of the one or more ethylenically unsaturated nonionic monomers and the one or more ethylenically unsaturated cationic monomers is from about 3:100 to about 6:100. The at least one associative inverse emulsion cationic polymer is formed from a polymerization reaction that is initiated and carried out by a single charge of an initiator. The polymer that is produced is an associative and branched or crosslinked cationic polymer that is physically and chemically cross-linked with diblock and triblock polymeric surfactants. When the composition is added to an aqueous sludge, the treated sludge is dewatered using whatever process is in place in the waste water processing facility, such as filtration or centrifugation.

The present disclosure also relates to a method of increasing filter cake dryness in sludge dewatering processes that includes at least one associative inverse emulsion cationic polymer, wherein the associative properties of the cationic polymer are provided by an emulsification surfactant chosen from diblock and triblock polymeric surfactants. wherein the at least one associative inverse emulsion cationic polymer comprises one or more polymer segment “A” comprised of ethylenically unsaturated nonionic monomers; and one or more cationic polymer segment “B” comprised of ethylenically unsaturated cationic monomers; and a cross-linking agent. The composition also includes an emulsification surfactant chosen from diblock polymeric surfactants, triblock polymeric surfactants and combinations thereof; wherein the molar ratio of the emulsification surfactant to a combination of the one or more ethylenically unsaturated nonionic monomers and the one or more ethylenically unsaturated cationic monomers is from about 3:100 to about 6:100. The at least one associative and/or branched inverse emulsion cationic polymer is formed from a polymerization reaction using an initiator. The polymer that is produced is an associative and/or branched cationic polymer that is physically and chemically cross-linked. When the composition is added to an aqueous sludge, the treated sludge is then dewatered using whatever process is in place in the waste water processing facility, such as filtration or centrifugation.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

Unless specifically stated or obvious from context, as used herein, the term “about” is understood as within a range of normal tolerance in the art, for example within 2 standard deviations of the mean. “About” can be understood as within 10%, 5%, 1%, 0.5%, 0.1%, 0.05%, or 0.01% of the stated value. “about” can alternatively be understood as implying the exact value stated. Unless otherwise clear from the context, all numerical values provided herein are modified by the term “about.”

The aqueous sludge to be dewatered by the process according to the invention is not particularly limited. The aqueous sludge as a starting material comes from, for example, mining sludge, municipal sludge and industrial sludge. It may be digested sludge, activated sludge, coarse sludge, raw sludge, and the like, and mixtures thereof.

The present method relates to the dewatering of aqueous sludge. The method includes treating the aqueous sludge with an associative and branching or cross-linked copolymer composition that is produced through an inverse emulsion polymerization that is initiated using an initiator.

The present process is a departure from the above process in that composition comprises an associative and branched or cross-linked polymer, emulsification surfactant(s), and aqueous sludge as described in more detail below.

In particular, an aqueous sludge is treated with at least one associative and branching or cross-linked inverse emulsion cationic polymer, wherein the associative properties of the cationic polymer are provided by an emulsification surfactant(s) chosen from diblock and triblock polymeric surfactants. Although not to be bound by any particular theory, it is believed that the cationic polymer and emulsification surfactant together with a cross-linking agent, form a chemical and physical network or structure via the polymerization reaction. The formation occurs with incorporation of the emulsification surfactant thereby making a physical and chemical network of cross-linking agent together in the polymer. In processes used today, this structuring does not occur and a physical and chemical network is not formed because there is no associated interaction with the emulsification surfactant.

In some aspects of the current method, the at least one associative and branching or cross-linked inverse emulsion cationic polymer comprises one or more polymer segment “A” comprised of ethylenically unsaturated nonionic monomers; one or more cationic polymer segment “B” comprised of one or more ethylenically unsaturated cationic monomers; and a cross-linking agent. The molar ratio of emulsification surfactant(s) to monomer can be from about 3:100 to about 6:100. The polymerization reaction is initiated by an initiator and the reaction is allowed to continue until judged sufficiently complete. No additional initiators or additional monomers need to be added after the start of the polymerization reaction. If desired an initiator that is the same or different from the initial initiator can be added as a burn-out charge to reduce any residual monomer. The resulting copolymer composition is added to an aqueous sludge and the treated aqueous sludge is dewatered through currently used techniques, such as filtration and/or centrifugation to produce a filter cake.

In some aspects of the current method, the initial temperature of the polymerization reaction is between 55 degrees C. (° C.) and 65° C. and a pH of from about 2 to less than 7.

In some aspects of the current method, the one or more ethylenically unsaturated nonionic monomers is chosen from acrylamides, methacrylamides, N-dialkylacrylamides, N-alkylacrylamides, and mixtures thereof.

In some aspects of the current method, the one or more ethylenically unsaturated cationic monomers (CPAMs) are chosen from acryloyloxyethyltrimethyl ammonium chloride (AETAC), DAC and DAC-80 (2-acryloxyethyltrimethylammonium chloride), DMAEA (dimethylaminoethyl acrylate), DMAEA-Q (dimethylaminoethyl acrylate methyl chloride quat.), 2-((1-oxo-2-propenyl)oxy)-N,N,N-trimethylethanaminium chloride, ADAME-Q (2-(dimethylamino)ethyl acrylate methochloride), Adamquat 80 MC, EC 256-176-6; EINECS 256-176-6; Ethanaminium, N,N,N-trimethyl-2-((1-oxo-2-propenyl)oxy)-, chloride; UNIT-2VO170W0XM; (2-(acryloyloxy)ethyl)trimethylammonium chloride; Ethanaminium (2-((1-oxo-2-propenyl)oxy)-N,N,N-trimethylchloride), Ethanaminium (N,N,N-trimethyl-2-((1-oxo-2-propen-1-yl)oxy) chloride 1:1), Ethanaminium (N,N,N-trimethyl-2-((1-oxo-2-propenyl)oxy) chloride), (2-acryloyloxyethyl)-N,N,N-trimethylammonium chloride, [2-(acryloyloxy)ethyl]trimethylammonium chloride solution, 2-(acryloyloxy)-N,N,N-trimethylethanaminium chloride, for example.

The copolymer composition can be described as comprising the formula (I)

-[A-co-B]— (I)

wherein A is a nonionic polymer segment formed from the polymerization of the one or more ethylenically unsaturated non-ionic monomers and B is a cationic polymer segment formed from the one or more ethylenically unsaturated cationic monomers.

In some aspects of the current method, the molar % ratio of A:B is from 95:5 to 5:95; and the copolymer composition is prepared via a water-in-oil emulsion polymerization technique that employs at least one emulsification surfactant consisting of at least one diblock or triblock nonionic polymeric surfactant(s).

In some aspects of the current method, an aqueous solution of monomers is prepared and placed in contacted with an aqueous solution containing an emulsification surfactant or surfactant mixture to form an inverse emulsion, thereby causing the monomer in the emulsion to polymerize by free radical polymerization by the use of specific initiators at a pH range of from about 2 to less than 7. The resulting polymer is a cross-linked, associative cationic polymer.

In some aspects of the current method, the associative and branching or cross-linked polymer is a cationic copolymer, with a molar ratio of nonionic monomer to cationic monomer (A:B of Formula I) may fall within the range of 99:1 to 50:50, or 95:5 to 50:50, or 95:5 to 75:25, or 90:10 to 60:45, can be from about 85:15 to about 60:40 and may be from about 80:20 to about 50:50. In this regard, the molar percentages of A and B must add up to 100%. It is to be understood that more than one kind of nonionic monomer may be present in the Formula I. It is also to be understood that more than one kind of cationic monomer may be present in the Formula I.

In some aspects of the current method, the cross-linking agent is chosen from N,N-methylene bis acrylamide (MBA), tetraallyl ammonium chloride (TAAC) and combinations thereof with the proviso that the cross-linking agent is not selected from HMA (N-hydroxymethyl acrylamide, HEMA/HEA (2-hydroxyethyl (meth)acrylate, PEG-diacrylate (M=1000 g/mol), TAAC (tetraallyl ammonium chloride, DMA (Dimethylacrylamide), pentaerythritol-triacrylate, DPEPA (dipentaerythritol-pentaacrylate), and 1,3,5-triacryloylhexahydro-1,3,5-triazine, since the desired result were not obtained.

In yet other aspects of the current method, the one or more ethylenically unsaturated nonionic monomers is acrylamide; the one or more ethylenically unsaturated cationic monomers is acryloyloxyethyltrimethyl ammonium chloride, and the initiator is chosen from peroxides, persulfates, and azo compounds, and can be lauroyl peroxide.

In some aspects of the current method, the cross-linking agent is present in an amount of about 0.5 ppm to about 25 ppm by weight or about 1.0 ppm to about 20 ppm by weight of the total weight of the associative and branching or cross-linked polymer composition.

In yet other aspects of the current method, the emulsification surfactant(s) of the polymerization products that are used to produce the associative and branching or cross-linked polymer includes at least one diblock and/or triblock polymeric surfactant, wherein the diblock and triblock copolymers are chosen from copolymers based on polyester derivatives of fatty acids and poly(ethylene oxide); copolymers based on polyisobutylene succinic anhydride and poly(ethylene oxide); reaction products of ethylene oxide and propylene oxide with ethylenediamine; and mixtures thereof.

In some aspects of the current method, the amount of the polymeric emulsification surfactant comprises about 1.0 wt. % to about 3.0 wt. % of the total copolymer composition, can be about 1.5 wt. % to about 2.5 wt. % of the total copolymer composition and may be about 1.8 wt. % to about 2.3 wt. % of the total cationic copolymer.

In some aspects of the current method, the amount of diblock or triblock copolymers to monomer is about 4:100 to 5:100.

In yet other aspects of the current method, the emulsification surfactant is a triblock emulsifier comprising a polyester derivative of fatty acids and poly[ethyleneoxide].

In some aspects of the current method, the polymerization reaction is initiated by introducing an initiator to start the polymerization reaction. The initiator can be chosen from a thermal initiator, an organic peroxide initiator, a redox initiator or an azo-initiator. In particular, organic peroxide initiators, such as lauroyl peroxide (also named didodecanoyl peroxide, dilauroyl peroxide, di(dodecanoyl) peroxide, and dodecanoyl peroxide), have shown efficacy in initiating the polymerization reaction.

In some aspects of the current method, the first charge of initiator is in an amount of not more than about 250 ppm of the associative and branching or cross-linked polymer composition. The initiator can be in an amount of about 0.0025 wt. % to about 0.0075 wt. %, or about 0.0040 wt. %, or about 0.0050 wt. % to about 0.0065 wt. % of the associative and branching or cross-linked polymer composition.

In other aspects of the current method, the copolymer composition can further comprise chelating agents, surfactants, stabilizers, and oils.

In some aspects of the current method, the aqueous sludge being treated is from waste water from municipal, industrial, papermaking processes, or mining sludge coming from tailings dewatering.

In some aspects of the current method, the treated aqueous sludge is dewatered by centrifugation techniques.

The present disclosure also relates to a method of increasing filter cake dryness in sludge dewatering processes that includes treating the aqueous sludge with at least one associative and branching or cross-linked inverse emulsion cationic polymer, wherein the associative properties of the cationic polymer are provided by an emulsification surfactant(s) chosen from diblock and triblock polymeric surfactants; wherein the associative and branching or cross-linked inverse emulsion cationic polymer comprises one or more polymer segment “A” comprised of ethylenically unsaturated nonionic monomers; and one or more cationic polymer segment “B” comprised of one or more ethylenically unsaturated cationic monomers; and a cross-linking agent. The molar ratio of emulsification surfactant(s) to monomer can be from about 3:100 to about 6:100. The treated aqueous sludge is then dewatered through techniques currently installed at the particular facility that is dewatering the aqueous sludge, such as filtration and/or centrifugation; to form a filter cake.

In some aspects of the current method, the initial temperature of the polymerization reaction is between 55° C. and 65° C. and a pH of from about 2 to less than 7.

In some aspects of the current method, the one or more ethylenically unsaturated nonionic monomers is chosen from acrylamides, methacrylamides, N-dialkylacrylamides, N-alkylacrylamides, and mixtures thereof.

In some aspects of the current method, the one or more ethylenically unsaturated cationic monomers (CPAMs) are chosen from acryloyloxyethyltrimethyl ammonium chloride (AETAC), DAC and DAC-80 (2-acryloxyethyltrimethylammonium chloride), DMAEA (dimethylaminoethyl acrylate), DMAEA-Q (dimethylaminoethyl acrylate methyl chloride quat.), 2-((1-oxo-2-propenyl)oxy)-N,N,N-trimethylethanaminium chloride, ADAME-Q (2-(dimethylamino)ethyl acrylate methochloride), Adamquat 80 MC, EC 256-176-6; EINECS 256-176-6; Ethanaminium, N,N,N-trimethyl-2-((1-oxo-2-propenyl)oxy)-, chloride; UNIT-2VO170W0XM; (2-(acryloyloxy)ethyl)trimethylammonium chloride; Ethanaminium (2-((1-oxo-2-propenyl)oxy)-N,N,N-trimethylchloride), Ethanaminium (N,N,N-trimethyl-2-((1-oxo-2-propen-1-yl)oxy) chloride 1:1), Ethanaminium (N,N,N-trimethyl-2-((1-oxo-2-propenyl)oxy) chloride), (2-acryloyloxyethyl)-N,N,N-trimethylammonium chloride, [2-(acryloyloxy)ethyl]trimethylammonium chloride solution, 2-(acryloyloxy)-N,N,N-trimethylethanaminium chloride, for example.

In yet other aspects of the current method, the one or more ethylenically unsaturated nonionic monomers is acrylamide; the one or more ethylenically unsaturated cationic monomers is acryloyloxyethyltrimethyl ammonium chloride, and the initiator is lauroyl peroxide.

In some aspects of the current method, the cross-linking agent is chosen from N,N-methylene bis acrylamide (MBA), tetraallyl ammonium chloride (TAAC) and combinations thereof.

In other aspects of the current method, the cross-linking agent is present in an amount of about 0.5 ppm to about 25 ppm by weight or about 1.0 ppm to about 20 ppm by weight of the total weight of the associative and branching or cross-linked polymer composition.

In some aspects of the current method, the diblock or triblock copolymers are chosen from copolymers based polyester derivatives of fatty acids and poly(ethylene oxide); copolymers based on polyisobutylene succinic anhydride and poly(ethylene oxide); reaction products of ethylene oxide and propylene oxide with ethylenediamine; and mixtures thereof.

In some aspects of the current method, the amount of the emulsification surfactant comprises about 1.0 wt. % to about 3.0 wt. % of the total copolymer composition, can be about 1.5 wt. % to about 2.5 wt. % of the total copolymer composition and may be about 1.8 wt. % to about 2.3 wt. % is 2.1 wt. % of the total cationic copolymer.

In other aspects of the current method, the amount of diblock or triblock copolymers to monomer is about 4:100 to 5:100.

In some aspects of the current method, the emulsification surfactant is a triblock emulsifier.

In some aspects of the current method, the initiator is chosen from a thermal initiator, an organic peroxide initiator, a redox initiator or an azo-initiator.

In some aspects of the current method, the initiator is an organic peroxide initiator.

In some aspects of the current method, the organic peroxide initiator is lauroyl peroxide.

In some aspects of the current method, the initiator is in an amount of not more than 250 ppm by weight based on the total weight of the associative and branching or cross-linked polymer composition.

In some aspects of the current method, an initiator can optionally be added as a burnout charge to reduce any residual monomer.

In other aspects of the current method, the associative and branching or cross-linked polymer composition can further comprise chelating agents, surfactants and oils.

In some aspects of the current method, the filter cake dryness is increased by at least 8%, can be at least 10% when compared with filter cakes made using standard polymer compositions.

### EXAMPLES

### Preparation of the Standard and the Associative and Branching or Cross-Linked Polymer Compositions

In a first 2-liter beaker an aqueous phase composition was prepared using a mixture of 276 grams (g) acrylamide (50 wt %), 0.6 g Trilon® C (pentasodium diethylenetriaminepentaacetate, chelating agent), 394 g ADAME® Quat (80 wt %, cationic acrylic monomers), 90 g water, and 2 ppm by weight of the aqueous phase (or 4.4 ppm based on the monomer concentration in the batch (45 wt. %)) N,N′-methylene bis acrylamide (MBA) cross-linker. The mixture was added to a first 2-liter beaker and stirred. The pH of the mixture was adjusted to pH 3 using sulphuric acid.

In a second 2-liter beaker, an organic or oil phase composition was prepared by mixing 20 grams (g) Zephrym® 7053 (emulsifier), 3 g Degacryl® 3059 L (methacrylic emulsifier), 12.7 g Intrasol® FA1218/5 (ethoxylated fatty alcohol surfactant) and 247 g paraffin oil.

The aqueous phase was then charged to the oil phase under vigorous stirring followed by mixing with a homogenizer to obtain a stable water-in-oil inverse emulsion. The resulting emulsion was placed into a 2-liter glass reaction vessel equipped with an anchor stirrer, thermometer and a distillation device and the emulsion was evacuated. The temperature of the emulsion was adjusted to 63±1° C. after 30 min of air stripping.

The polymerization was initiated by an initial charge of a 1 wt. % 2,2′-azobis(2,4-dimethyl valeronitrile (15 g of V-65, i.e. azo initiator in oil). The amount of distillate under negative pressure was 110 ml. After the distillation, the vacuum was removed. The residual monomers could react adiabatically reaching a maximum temperature of 70° C. The emulsion was stirred for an additional 15 minutes, and vacuum was again applied, and the temperature of the composition was allowed to cool to 40° C. At this time, 2 g sodium peroxodisulfate (25 wt. %) and 11 g sodium bisulfate (25 wt. %) were added to the composition to reduce the monomer content. As a last step, an activator was added under stirring to the final product.

The aqueous phase of the new associative and branching or cross-linked polymer composition was prepared as described above. The organic or oil phase was prepared by mixing 24 g Hypermer B246SF (triblock polymeric surfactant), 2 g sorbitane monooleate and 249 g paraffin oil and 15 g of a (1 wt. %) lauroyl peroxide as an initiator.

### Example 1—Dewatering of an Aqueous Sludge

Samples of aqueous sludge was obtained from three different waste water facilities located in Germany, i.e. Koln; Angertal; and Essity Mannheim. From each facility, two 500 milliliter (ml) samples of sludge were treated with two different dosages of a standard drainage aid that were used as a benchmark in the study. The sludge from each of the facilities was treated with two different dosage levels as indicated in Table 1. The samples were sheared at 1000 rpm with a four-fingered stirrer for 10-20 seconds, to simulate the centrifuges used in the dewatering facilities. The aqueous sludge was dewatered using a 315 micron (μm) metallic sieve. The amount of filtrate was measured, and the clarity of the filtrate determined using a graduated measuring wedge.

A plexiglass disc was used to cover the filter cake that remained in the sieve and a 10-kilogram (kg) weight was placed on top of the plexiglass disc for 1 minute at which time cake compactness was evaluated by visual inspection to determine if the filter cakes press ability was good, fair, or bad. Second, a part of the pressed filter cake (weighted) with placed in a heating oven at 105° C. overnight. The dried filter cake was weighed back and the total solids (TS) of the cake was noted.

TABLE 1
Results of Dry Matter Test

| | | | | |
|---|---|---|---|---|
| | Dosage | Dry Substance | | Improvement |
| Samples | [ppm] | [%] | Average | [%] |

KA Köln-Langel

| | | | | |
|---|---|---|---|---|
| Standard | 220 | 9.2 | 9.7 | 10.3 |
| Composition | 260 | 10.1 | | |
| New | 220 | 10.7 | 10.7 | |
| Composition | 260 | 10.7 | | |

KA Angertal

| | | | | |
|---|---|---|---|---|
| Standard | 290 | 10.3 | 10.6 | 5.7 |
| Composition | 330 | 10.9 | | |
| New | 290 | 10.9 | 11.0 | |
| Composition | 330 | 11.2 | | |

Essity Mannheim

| | | | | |
|---|---|---|---|---|
| Standard | 9.0 | 13.0 | 13.1 | 8.4 |
| Composition | 10.1 | 13.2 | | |
| New | 9.00 | 14.0 | 14.2 | |
| Composition | 10.1 | 14.4 | | |

As can be seen from the results in Table 1 and FIG. 1, the new dewatering composition shows improvement in dewatering in all cases wherein the new composition is shown to provide up to 10.3% drier matter when compared with a standard dewatering composition currently used in the industry.

### Example 2—Dewatering of an Aqueous Sludge

The same procedure for treating sludge that was used in Example 1 was used for this study, except the aqueous sludge came only from Koln-Langel and was treated at one dosage level as indicated in Table 2 and FIG. 2.

In this study, the 500 ml of treated or conditioned sludge was sheared as described above and then placed in a Britt Jar and the amount of time to collect 300 ml of filtrate was noted. A vacuum of about 20 mbar (0.29 psi) was applied to the sludge or filter cake that was in the britt jar for 20 seconds at which time a plexiglass disc was placed on top of the remaining sludge or filter cake and a 5-kilogram (kg) weight placed on top of the plexiglass. The vacuum was reapplied for an additional 1 minute and the filter cake tested for percent dry matter (OS).

TABLE 2
Results of Dry Matter Test from Modified Britt Jar

| | dosage | Dry Matter | | Improvement |
|---|---|---|---|---|
| Sample | [ppm] | [%] | Std dev | [%] |
| Standard | 360 | 8.2 | 0.2 | 11.5 |
| Composition | | | | |
| New | 360 | 9.2 | 0.1 | |
| Composition | | | | |

As can be seen from the results shown in Table 2, the “New” composition outperformed the “Standard” composition with regard to residue dry matter in the filter cake.

### Example 3—Sedimentation Time and Clarity

The testing procedure used in Example 1, was followed here. An aqueous sludge was obtained, treated, filtered, and pressed as described in Example 1. Results from the KA Köln-Langel sludge can be found in Table 3, results from the KA Angertal sludge in Table 4, and results from the Essity Mannheim sludge in Table 5.

TABLE 3
KA Köln-Langel Sludge

| | 220 ppm = 9.6 kg/t | | | 260 ppm = 11.3 kg/t | | |
|---|---|---|---|---|---|---|
| | | | TS cake | | | TS cake |
| | Sedimentation | | solid | Sedimentation | | solid |
| | time [s] | Clarity | [%] | time [s] | Clarity | [%] |
| New | 5 | 20 | 10.7 | <3 | 25 | 10.7 |
| Composition | | | | | | |
| New | 14 | 12 | 10.2 | 6 | 17 | 11.0 |
| Composition | | | | | | |
| (Repeat) | | | | | | |
| What is the “old” | 20 | 5 | 9.2 | 8 | 9 | 10.1 |
| composition (we | | | | | | |
| need the | | | | | | |
| chemical name | | | | | | |

KA Angertal Sludge

| | 290 ppm | | | 330 ppm | | |
|---|---|---|---|---|---|---|
| | | | TS cake | | | TS cake |
| | Sedimentation | | solid | Sedimentation | | solid |
| | time [s] | Clarity | [%] | time [s] | Clarity | [%] |
| New | 7 | 24 | 10.9 | <3 | 46 | 11.2 |
| composition | | | | | | |
| Standard | 16 | 9 | 10.3 | 5 | 17 | 10.9 |
| composition | | | | | | |

Essity Mannheim Sludge

| | 300 ppm = 9.0 kg/t | | | 340 ppm = 10.1 kg/t | | |
|---|---|---|---|---|---|---|
| | | | TS cake | | | TS cake |
| | Sedimentation | | solid | Sedimentation | | solid |
| | time [s] | Clarity | [%] | time [s] | Clarity | [%] |
| New | 4 | 7 | 14.0 | <3 | 12 | 14.4 |
| composition | | | | | | |
| Standard | 13 | 1 | 13.0 | 5 | 3 | 13.2 |
| composition | | | | | | |

Sedimentation (time for 300 ml filtrate): lower is better.
Clarity (filtrate in turbidity wedge): higher is better.
TS cake solid (105° C., overnight): higher is better.

Results shown in Table 3, indicates that the “New” composition outperforms the “Standard” composition.

Studies have shown that the residual dry matter (OS) in the filter cake can be improved by as much as 10.3% when compared with the Standard composition.

While at least one exemplary embodiment has been presented in the foregoing detailed description of the inventive subject matter, it should be appreciated that a vast number of variations exist. It should also be appreciated that the exemplary embodiment or exemplary embodiments are only examples, and are not intended to limit the scope, applicability, or configuration of the inventive subject matter in any way. Rather, the foregoing detailed description will provide those skilled in the art with a convenient road map for implementing an exemplary embodiment of the inventive subject matter. It being understood that various changes may be made in the function and arrangement of elements described in an exemplary embodiment without departing from the scope of the inventive subject matter as set forth in the appended claims.

What is claimed is:

1. A method of dewatering aqueous sludge comprising:
a. treating the aqueous sludge with an associative and branching or cross-linked polymer composition comprising:
at least one associative and branching or cross-linked cationic polymer, wherein the associative properties of the cationic polymer are provided by an emulsification surfactant chosen from diblock and triblock polymeric surfactants;
wherein the at least one associative and branching or cross-linked cationic polymer comprises one or more polymer segment “A” comprised of ethylenically unsaturated nonionic monomers; and one or more cationic polymer segment “B” comprised of ethylenically unsaturated cationic monomers; and a cross-linking agent;
wherein the molar ratio of the emulsification surfactant to a combination of the one or more ethylenically unsaturated nonionic monomers and the one or more ethylenically unsaturated cationic monomers is from about 3:100 to about 6:100; and
wherein the at least one associative and branching or cross-linked cationic polymer is formed from a polymerization reaction that is initiated by an initiator; and
b. dewatering the treated aqueous sludge obtained from step a).

2. The method according to claim 1, wherein the initial temperature of the polymerization reaction is between 55° C. and 65° C. and a pH of from about 2 to less than 7.

3. The method according to claim 1, wherein the one or more ethylenically unsaturated nonionic monomers is chosen from acrylamides, methacrylamides, N-dialkylacrylamides, N-alkylacrylamides, and mixtures thereof.

4. The method according to claim 1, wherein the one or more ethylenically unsaturated cationic monomers is chosen from acryloyloxy)ethyl)trimethylammonium chloride, 2-acryloxyethyltrimethylammonium chloride, dimethylaminoethyl acrylate, dimethylaminoethyl acrylate methyl chloride quat., 2-((1-oxo-2-propenyl)oxy)-N,N,N-trimethylethanaminium chloride, (2-(dimethylamino)ethyl acrylate methochloride), N,N,N-trimethyl-2-((1-oxo-2-propenyl)oxy)chloride, (2-(acryloyloxy)ethyl)trimethylammonium chloride, (2-((1-oxo-2-propenyl)oxy)-N,N,N-trimethylchloride, N,N,N-trimethyl-2-((1-oxo-2-propenyl)oxy) chloride, (2-acryloyloxyethyl)-N,N,N-trimethylammonium chloride, 2-(acryloyloxy)-N,N,N-trimethylethanaminium chloride and combinations thereof.

5. The method according to claim 1, wherein the cross-linking agent is chosen from N,N-methylene bis acrylamide (MBA) or tetraallyl ammonium chloride (TAAC).

6. The method according to claim 1, wherein the cross-linking agent is present in an amount of about 0.5 ppm to about 25 ppm by weight of the total weight of the associative and branching or cross-linked polymer composition.

7. The method according to claim 1, wherein the diblock and triblock copolymers are chosen from copolymers based polyester derivatives of fatty acids and poly(ethylene oxide); copolymers based on polyisobutylene succinic anhydride and poly(ethylene oxide); reaction products of ethylene oxide and propylene oxide with ethylenediamine; and mixtures thereof.

8. The method according to claim 1, wherein the amount of the emulsification surfactant comprises about 1.0 wt. % to about 3.0 wt. % of the total weight of the associative and branching or cross-linked polymer composition.

9. The method according to claim 1, wherein the amount of diblock or triblock copolymers to monomer is about 4:100 to 5:100.

10. The method according to claim 1, wherein the emulsification surfactant is a triblock emulsifier comprising a polyester derivative of fatty acids and poly[ethyleneoxide].

11. The method according to claim 1, wherein the initiator is an organic peroxide initiator.

12. The method according to claim 11, wherein the organic peroxide initiator is lauroyl peroxide.

13. The method according to claim 1, wherein the one or more ethylenically unsaturated nonionic monomers is acrylamide; the one or more ethylenically unsaturated cationic monomers is acryloyloxyethyltrimethyl ammonium chloride; and the initiator is lauroyl peroxide.

14. The method claimed in claim 1, wherein the initiator is in an amount of not more than 250 ppm based on the total weight of the associative and branching or cross-linked polymer composition.

15. The method according to claim 1, wherein an initiator is optionally added as a burn-out charge.

16. A method of increasing cake dryness in sludge dewatering processes comprising:
a) treating the aqueous sludge with an associative and branching or cross-linked polymer composition comprising:
at least one associative and branching or cross-linked inverse emulsion cationic polymer, wherein the associative properties of the cationic polymer are provided by an emulsification surfactant chosen from diblock and triblock polymeric surfactants;
wherein the at least one associative and branching or cross-linked inverse emulsion cationic polymer comprises one or more polymer segment “A” comprised of ethylenically unsaturated nonionic monomers; and one or more cationic polymer segment “B” comprised of ethylenically unsaturated cationic monomers; and a cross-linking agent; and
wherein the molar ratio of the emulsification surfactant to a combination of the one or more ethylenically unsaturated nonionic monomers and the one or more ethylenically unsaturated cationic monomers is from about 3:100 to about 6:100; and
wherein the at least one associative and branching or cross-linked inverse emulsion cationic polymer is formed from a polymerization reaction that is initiated by an initiator; and
dewatering the treated aqueous sludge obtained from step a) producing a filter cake.

17. The method according to claim 16, wherein the amount of the emulsification surfactant comprises about 1.0 wt. % to about 3.0 wt. % of the total copolymer composition.

18. The method claimed in claim 16, wherein the initiator is in an amount of not more than 250 ppm by weight based on the total weight of the associative and branching or cross-linked inverse emulsion cationic polymer composition.

19. The method according to claim 16, wherein an initiator chosen from a persulfate, a bisulfate, or a combination thereof, is optionally added as a burn-out charge.

20. The method according to claim 16, wherein the filter cake dryness is increased by at least 10% when compared with filter cakes made using standard polymer compositions.
